(19) United States
(12) Patent Application Publication
(10) Pub. No.: US 2018/0319567 A1
(43) Pub. Date: Nov. 8, 2018

(54) MULTI-CHAMBER FILM BAG AND USE THEREOF

(71) Applicant: HILTI AKTIENGESELLSCHAFT, Schaan (LI)

(72) Inventors: Jekaterina MILLER, Augsburg (DE); Esther Rahel KLUJ, Landsberg (DE); Mario PAETOW, Igling (DE)

(73) Assignee: HILTI AKTIENGESELLSCHAFT, Schaan (LI)

(21) Appl. No.: 15/769,983

(22) PCT Filed: Oct. 24, 2016
(86) PCT No.: PCT/EP2016/075493

§ 371 Date: Apr. 20, 2018

(30) Foreign Application Priority Data
Oct. 30, 2015 (EP) 15192406.5

(51) Int. Cl. B65D 81/32; C04B 28/04; C04B 28/14; C04B 40/06

(52) U.S. Cl. CPC B65D 81/3266; C04B 40/065; C04B 28/14; C04B 28/04

(57) ABSTRACT

A multi-chamber film bag can be used for an inorganic multi-component foam system. The bag has at least two chambers separated from one another in liquid-tight manner, where one of the chambers is filled with a powdered inorganic component, optionally based on gypsum and/or cement mortar, and another chamber is filled with a liquid foaming component for the powdered inorganic component. The bag also has a separating element, which in a first condition separates the chambers from one another in liquid-tight manner and in a second condition provides fluidic communication between the chambers. At least one of the chambers has an opening portion, which can be opened to discharge the foam system.

The invention relates to a multi-chamber film bag for an inorganic multi-component foam system and to the use of the multi-chamber film bag for packaging and/or processing of an inorganic multi-component foam system. Furthermore, the invention relates to the use of the multi-chamber film bag in a process for manufacturing a foam-in-place foam, especially an inorganic fire-protection foam.

For rapid sealing of openings, such as fire-protection penetrations in the building sector, for example, a reactive material of two components is mixed in place and introduced into the opening. The reactive material should be stable until it cures, so that it does not flow back out of the opening.

In two-component liquid resins such as polyurethane or epoxy resin, stability is achieved by appropriate adjustment of the viscosity of the material. The reactive components are introduced separately into two-component cartridges and mixed with a static mixer. Static mixers are not suitable for mixtures of powder components and liquids, however, because bridging takes place in the powder component and prevents mixing by pressure in the static mixer.

Compounds consisting of powders and liquids are therefore mechanically mixed with one another in an open vessel by means of stirring rods or other mixing aids.

The mixed compound may then be introduced manually into the opening to be filled and/or transformed to the desired shape, or are filled into further application aids, such as kneading presses, for example, and introduced into the opening.

If the powder is to be mixed with the liquid in a closed container, further aids such as balls, for example, are needed in a space partly filled with air. A substantially liquid consistency of the mixture is necessary for emptying the container.

Liquid two-component grouting resins are further known, which are introduced in a two-chamber film bag with clamp-type closure. In this case the grouting resin is mixed manually after removal of the clamp-type closure and is then poured into cable lugs, for example.

Multi-component systems for manufacturing gypsum foams and/or cement foams by mixing in open vessels are known, for example, from EP 2 045 227 A. That document describes a hydraulically binding composition for manufacturing inorganic fire-protection or insulating foam-in-place foams with a pH-neutral or alkaline hydraulic binder and a foaming component as well as a foam stabilizer, wherein the foaming component releases oxygen or carbon dioxide. However, the known inorganic fire-protection systems can be introduced into openings only with difficulty and are frequently usable only as a grouting compound with complex formwork devices.

Simple and inexpensive packaging for rapid mixing of the powdered and liquid components for an inorganic foam based on gypsum or mortar in a closed container is not known. Therefore such inorganic foam systems have not been common on the market heretofore, despite a relatively low material price.

The object underlying the invention is to provide a simple, user-friendly and inexpensive form of use and packaging for rapid mixing of powders and liquids in a closed container, especially for an inorganic foam on the basis of gypsum and/or mortar for fire-protection purposes.

The form of use should permit mixing of the compounds without complex tools and make it possible to introduce the foam system even into openings that are narrow and/or difficult to access.

This object is solved by a multi-chamber film bag according to claim 1. Subject matter of the invention is further the use of the multi-chamber film bag according to claim 10 for packaging and/or processing of an inorganic multi-component foam system, as well as a process for manufacturing a foam-in place foam from an inorganic multi-component foam system using the inventive multi-chamber film bag having the features of claim 11.

Advantageous and expedient configurations of the inventive process and of the inventive film bag are specified in the associated dependent claims.

The invention provides a multi-chamber film bag for an inorganic multi-component foam system, with at least two chambers separated from one another in liquid-tight manner, wherein at least one of the chambers is filled with a powdered inorganic component, preferably based on gypsum and/or cement mortar, and at least one other chamber with a liquid foaming component for the powdered inorganic component. Furthermore, the multi-chamber film bag comprises a separating element, which in a first condition separates the chambers from one another in liquid-tight manner and in a second condition provides fluidic communication between the chambers. At least one of the chambers has an opening portion, which can be opened to discharge the foam system.

The inventive multi-chamber film bag makes it possible to provide a film package with fixed quantities, predetermined by the packaging, of the reactive components for the inorganic foam system. Thus erroneous dosing by the user can be reliably prevented and the mixture is ready for immediate use. The separating element of the multi-component film bag can be opened simply without tools. Good mixing results can be achieved by simple kneading of the components. No mixing and expelling tools are needed to discharge the foam system. Nevertheless, it is still possible to use the inventive film bag or film tube to discharge residual quantities with a known film dispenser for one-component compounds.

The opening portion provided for discharge of the foam system in at least one of the chambers may be constructed as a nozzle tip and in this way permit dosing of the foam system into openings that are narrow and difficult to access. Furthermore, after the components have been mixed in the film bag, the foam system can already be present in stable pasty consistency, in order to prevent the compound from flowing out of the openings to be filled.

Furthermore, inexpensive and space-saving film packaging is provided with the invention. During mixing of the reactive components in the film bag, no dust generation is able to develop from the powdered component. Contact of the user with the reactive foam components during mixing is excluded, and so a health hazard due to reactive components is avoided. Finally, cleaning of mixing tools and mixing containers is also not necessary, since mixing of the components takes place inside the film packaging.

Although the invention is described hereinafter on the basis of a two-component foam system, multi-component systems, which contain more than two reactive components that can be introduced into more than two chambers separated from one another in the film bag by separating elements, are also comprised by the invention and can be implemented with little complexity.

According to a preferred embodiment, the multi-component foam system is a two-component foam system of an inorganic fire-protection foam or insulating foam with at least one hydraulic binder, at least one foaming system and optionally a foam stabilizer. Cements, especially Portland cement, trass, pozzolan, hydraulic lime and gypsum or mixtures thereof may be used as the hydraulic binder. The foaming system may be formed, for example, from an an alkali metal or alkaline earth carbonate or bicarbonate as the powdered component and an acid as the liquid foaming component or alternatively from carbonate (e.g. sodium carbonate) dissolved in water as the liquid foaming component and a solid acid (e.g. citric acid) as the powdered component.

Alternatively or additionally, the foaming system may comprise an oxygen carrier and a catalyst. In particular, hydrogen peroxide in aqueous solution may be used as the oxygen carrier and liquid foaming component. The catalyst may comprise manganese dioxide, MnO2, in powder form. Such multi-component foam systems are known from EP 2 045 227 A1, to which reference is made herewith.

The separating element may be formed as a peel seam or as a clamping element. The peel seam may be made by heat-sealing or welding of the film walls of the film bag disposed opposite one another in a border region of a chamber, so that this chamber is separated in liquid-tight manner from the adjoining chamber of the film bag. By selection of the film material and/or by suitable film coatings, it is possible to adjust the tear strength of the peel seam such that the peel seam is torn open by pressure on one of the chambers and fluidic communication is established between the chambers.

According to a further embodiment, the separating element may be formed as a clamping seam. The clamping seam may be formed as a kind of lip-closure bag or zipper connection with two clamping slats engaging one in the other. Application of a clamping rail on the film bag from outside is also possible, wherein the film bag is placed with one flat side on the clamping rail provided with a longitudinal slit and then, with a flexible or rod-shaped clamping strip, pressed from the other flat side of the film bag into the longitudinal slit. Thereby the film walls of the film bag disposed opposite one another are pressed together, and liquid-tight separation of the chambers adjoining the clamp-type closure is formed in the film bag.

The clamping rail and/or the clamping strip may be supplied as loose parts. Thereby flexible subdivision of the chambers in the film bag is possible. According to a further embodiment, the clamping rail and/or the clamping strip may already be fastened on the outer wall of the film bag, for example by adhesive bonding or welding.

In an alternative embodiment, the separating element may be equipped with compulsory mixing joints, which permit faster and more homogeneous mixing of the powder components with the liquid. In particular, solid stays may be provided in the region of the separating element, between the films, disposed opposite one another, of the film bag, or weld seams may be provided, which remain intact and do not tear open due to pressure on one of the chambers.

The multi-chamber film bag may be formed as a stand-up bag, as a flat bag or else as a tubular bag. The manufacture of these systems is known in principle to the person skilled in the art. The bottom region of stand-up bags is usually made with a W-type fold, which expands in the bottom region during filling of the chamber and ensures a secure base for the film bag. Flat bags are usually formed by placing two plastic films one on top of the other and welding the films around the borders. Tubular bags are obtained by injecting the plastic films from round nozzles to form a film tube welding the ends of the tube on the bottom side or clamping the ends of the tube with a metal or plastic clip. Preferably, the multi-chamber film bag is formed as a flat bag with peripheral weld seam.

According to a further embodiment of the multi-chamber film bag, the opening portion for discharging the foam system is provided with a screw cap welded in the film bag. A screw cap makes it possible to attach commercial cartridge nozzles or nozzle tips, with which the foam system may be discharged from the film bag in a manner appropriate for the desired purpose of use at the point of application.

According to a further embodiment, the opening portion may be formed to discharge the foam system through a nozzle tip or plastic socket, preferably tapering sharply or conically, welded in the film bag. If necessary, the nozzle tip or socket may also be extended by slipping on a further plastic tip. Preferably, the nozzle tip or plastic socket is closed at its free end and, depending on the desired size of nozzle opening, will be cut to size at the point of application or may be broken off at a provided zone of weakness, such as a tear notch or an annular predetermined breaking point. Hereby no scissors or knives are needed. Thus filling of openings in the building is possible rapidly, easily and inexpensively.

Particularly preferably, the opening portion for discharging the foam system is formed by a socket molded in one piece onto the film bag. The socket may be tubular or may taper conically or sharply toward its free end opposite the chamber. Particularly preferably, the socket is provided at its free end with a weak zone, such as a tear seam, for example, to permit tearing of the socket without tools. In this way, even openings that are difficult to access can be filled rapidly, simply and inexpensively with the foam system.

Subject matter of the invention is therefore also a use of the multi-chamber film bag for packaging and/or processing of an inorganic multi-component foam system.

By use of the inventive multi-chamber film bag, it is possible to manufacture a foam-in-place foam from an inorganic multi-component foam system, wherein one of the chambers of the multi-chamber film bag is filled with a solid inorganic powder component and another chamber with a liquid foaming component for the solid inorganic powder component, wherein the chambers, in a first storage condition, are separated from one another in liquid-tight manner by a separating element and wherein, in a second ready-to-use condition, fluidic communication between the chambers is established by opening of the separating element and the powder component is mixed with the liquid foaming component. After the powder component and the foaming component have been mixed, the opening portion is opened and the foam formed in the film bag is discharged from the opening portion and introduced into an opening to be filled.

The inorganic multi-component foam system is preferably a two-component foam system, and particularly preferably a fire-protection foam.

Preferably, mixing of the inorganic powder component with the foaming component in the ready-to-use condition takes place by manual kneading of the compound in the sealed film bag.

Allowance for the expansion of the foam formed from the foam system during mixing because not the entire chamber volume is filled with the powder component and/or the liquid component. Thus a sufficient compensating volume is available in the film bag until mixing is complete and the opening portion can be opened.

By pressure on the end of the film bag opposite the opening portion, the foam formed from the foam system may then be discharged from the opening portion and introduced into the opening to be filled. The use of nozzle tips with a sharply tapering expulsion opening and a predetermined opening cross section permits selective introduction of the foam system even into narrow gaps with poor accessibility. The nozzle tips may be provided with weak zones, so that no scissors or knives are needed to open the expulsion tips. In this way, openings in the building can be filled rapidly, simply and inexpensively with the foam system.

Further features and advantages of the invention will become apparent from the description hereinafter and from the attached drawings, to which reference is made. In the drawings:

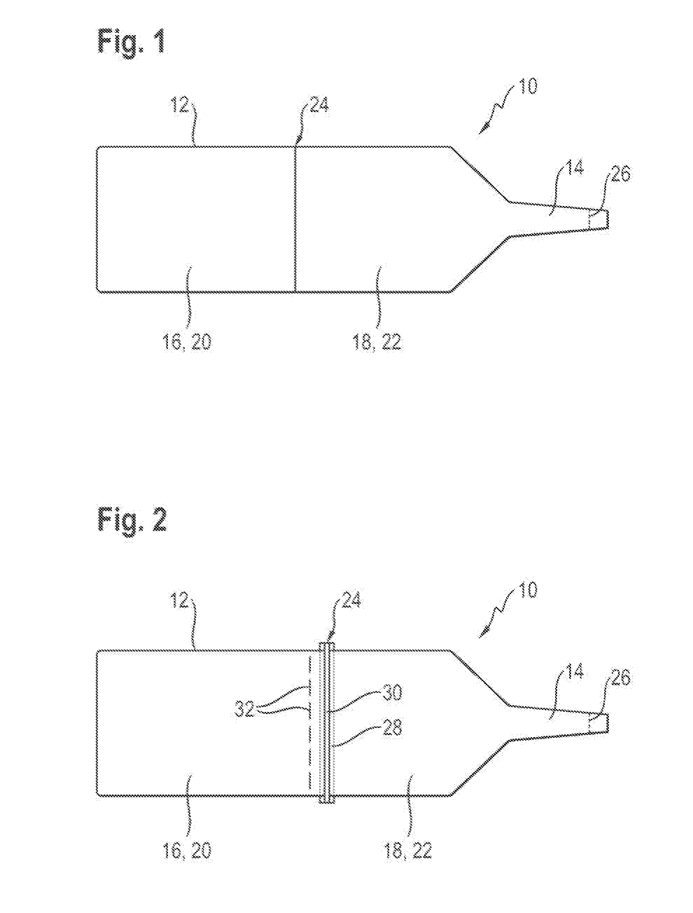

FIG. 1 shows a schematic diagram of the inventive film bag according to a first embodiment;

FIG. 2 shows a schematic diagram of the inventive film bag according to a further embodiment.

Multi-chamber film bag 10 illustrated in FIG. 1 is formed as a flat bag with peripheral weld seam 12 and an opening portion 14 in the form of a socket, molded in one piece onto the film bag, for discharging the foam system. Bag 10 has two chambers 16, 18, wherein chamber 16 contains a solid inorganic powder component 20 and the other chamber 18 contains a liquid foaming component 22 for the powder component. Chambers 16, 18 are bounded by weld seam 12 around the borders and a separating element 24, illustrated here as a heat-sealed peel seam. The peel seam provides liquid-tight separation of chambers 16, 18 in the storage condition of the film bag. Tear seam 26 formed on socket 14 for simplified opening of the bag is likewise shown. This may be advantageously supplemented or replaced by a notch.

Multi-chamber film bag 10 illustrated in FIG. 2 is likewise formed as a flat bag with peripheral weld seam 12 and an opening portion 14 in the form of a socket, molded in one piece onto the film bag, for discharging the foam system. Bag 10 has two chambers 16, 18, wherein the one chamber 16 contains solid inorganic powder component 20 and the other chamber 18 contains liquid foaming component 22. Chambers 16, 18 are bounded by weld seam 12 around the borders and a separating element 24, illustrated here as a clamping rail 28 with clamping slat 30. For liquid-tight separation of chambers 16, 18, clamping rail 28 is placed on one flat side of film bag 10 and then clamping strip 30 is pressed from the other flat side of film bag 10 into a longitudinal slit formed in the clamping rail. Thereby the film walls of film bag 10 disposed opposite one another are pressed together in the storage condition.

Compulsory mixing joints 32 in the form of continuous weld seams are further provided in the region of clamping element 24. After clamping element 24 has been opened in the ready-to-use condition of film bag 10, these provide for compulsory mixing of the components in chambers 16, 18. Tear seam 26 formed on socket 14 for simplified opening of the bag is likewise shown. This may be advantageously supplemented or replaced by a notch.

Instead of socket 14, a nozzle tip welded into the film bag or a screw cap may be provided, on which a cartridge nozzle may be attached,

In all embodiments, powder component 20 preferably comprises a hydraulically binding binder based on gypsum or cement mortar, as well as the solid components of the foaming system, such as an alkali metal or alkaline earth carbonate and/or a catalyst for release of oxygen from an oxygen carrier. The liquid foaming compound preferably comprises water as well as the liquid or dissolved components of the foaming system, such as an acid and/or hydrogen peroxide.

To manufacture a foam-in-place foam from inorganic multi-component foam system 20, 22, separating element 24 is opened and fluidic communication is established between chambers 16, 18. Film bag 10 then changes from the storage condition, in which chambers 16, 18 are separated from one another in liquid-tight manner, to the ready-to-use condition. By manual kneading, solid inorganic powder component 20 is mixed with liquid foaming component 22 to form a foam while opening portion 14 is closed. After mixing, opening portion 14 is opened and the foamed compound is discharged from the film bag by pressure on the end of the film bag opposite opening portion 14 and, by means of the socket on opening portion 14, is discharged directly into the opening to be filled in the building. There the compound may be subsequently shaped and cured.

### LIST OF REFERENCE SYMBOLS

10 Multi-chamber film bag

12 Weld seam

14 Socket

16 Chamber

18 Chamber

20 Solid inorganic powder component

22 Liquid foaming component

24 Separating element

26 Tear seam

28 Clamping rail

30 Clamping slat

32 Compulsory mixing joints

1. A multi-chamber film bag for an inorganic multi-component foam system, comprising:
at least two chambers separated from one another in liquid-tight manner, wherein one of the chambers is filled with a powdered inorganic component, optionally based on gypsum and/or cement mortar, and another chamber is filled with a liquid foaming component for the powdered inorganic component, and
a separating element, which in a first condition separates the chambers from one another in liquid-tight manner and in a second condition provides fluidic communication between the chambers,
wherein at least one of the chambers comprises an opening portion, which can be opened to discharge the foam system.

2. The multi-chamber film bag according to claim 1, wherein the multi-component foam system is a fire-protection foam.

3. The multi-chamber film bag according to claim 2, wherein the separating element is a peel seam or a clamping element.

4. The multi-chamber film bag according to claim 1, wherein
the separating element has a clamping seam or clamping rail with clamping strips.

5. The multi-chamber film bag according to claim 1, wherein
compulsory mixing joints are provided in the region of the separating element.

6. The multi-chamber film bag according to claim 1, wherein
the film bag is a stand-up bag, a fiat bag with edges welded around the borders, or a tubular bag.

7. The multi-chamber film bag according to claim 1, wherein
the opening portion comprises a screw cap.

8. The multi-chamber film bag according to claim 1, wherein
the opening portion comprises a nozzle tip of plastic welded into the bag.

9. The multi-chamber film bag according to claim 1, wherein
the opening portion comprises a socket with tear seam molded in one piece onto the film bag.

10. (canceled)

11. A process for manufacturing a foam-in-place foam from an inorganic multi-component foam system using a multi-chamber film bag according to claim 1, the process comprising:
filling one of the chambers of the multi-chamber film bag with a powdered inorganic component, optionally based on gypsum or cement mortar, and
filling another chamber with a liquid foaming component for the powdered inorganic component,
wherein the chambers, in a first storage condition, are separated from one another in liquid-tight manner by a separating element,
wherein, in a second ready-to-use condition, fluidic communication between the chambers is established by opening of the separating element and the powdered inorganic component is mixed with the foaming component, and
wherein the opening portion is then opened and the formed foam is discharged from the opening portion and introduced into the opening to be filled.

12. The process according to claim 11, wherein
the mixing of the powdered inorganic component with the liquid foaming component is achieved by manual kneading.

13. A process of packaging and/or processing an inorganic multi-component foam system in the multi-chamber film bag according to claim 1, the process comprising:
filling one of the chambers of the multi-chamber film bag with a powdered inorganic component, optionally based on gypsum or cement mortar, and
filling another chamber with a liquid foaming component for the powdered inorganic component.
